(19) United States
(12) Patent Application Publication
(10) Pub. No.: US 2017/0163642 A1
(43) Pub. Date: Jun. 8, 2017

(54) Method, Electronic Device and System for Content Pushing

(71) Applicants: Le Holdings (Beijing) Co., Ltd., Beijing (CN); LeCloud Computing Co., Ltd., Beijing (CN)

(72) Inventors: Ming LI, Beijing (CN); Ruiqian ZHAO, Beijing (CN)

(21) Appl. No.: 15/246,538

(22) Filed: Aug. 25, 2016

Related U.S. Application Data
(63) Continuation of application No. PCT/CN2016/089469, filed on Jul. 8, 2016.

(30) Foreign Application Priority Data
Dec. 7, 2015 (CN) 201510890215.X

(51) Int. Cl. H04L 29/06; H04L 29/08

(52) U.S. Cl. CPC H04L 63/0876; H04L 67/26; H04L 63/10

(57) ABSTRACT

Disclosed are a method and an electronic device for content pushing. The method mainly includes: obtaining, by a client, a device identity (ID) from an authentication server, wherein the device ID is a unique device identification assigned for the client by the authentication server; adding the device ID into a request for a content; and sending the request for the content to a CDN server, so that the CDN server returns the requested content to the client after authenticating the device ID.

### CROSS REFERENCE TO RELATED APPLICATIONS

This application is a continuation of International Application No. PCT/CN2016/089469, filed on Jul. 8, 2016, which is based upon and claims priority to Chinese Patent Application No. 201510890215.X, filed on Dec. 7, 2015, the entire contents of all of which are incorporated herein by reference.

### TECHNICAL FIELD

The present disclosure relates to internet technologies, and more particularly, to a method, an electronic device and a system for content pushing.

### BACKGROUND

At present, pretty much video player software is available. By downloading and installing one piece of video player software, users can view videos provided by the video player software. However, during the viewing of videos using the video player software, due to problems such as narrow network band width, large quantity of user accesses, and uneven distribution of network nodes, the speed for responding to users' requests for video contents may be influenced. As a result, in order to increase the speed for responding to users' requests for viewing video contents, some video providers usually publish, using Content Delivery Networks (CDNs), video contents onto a CDN node which is closest to users, and then the users can request the video contents from the CDN node.

Most videos are provided to users for free, and when a user requests to view a video, an optimal CDN node is determined for the user to ensure that the user can enjoy good viewing effects. Since common CDNs cannot recognize whether a video request is a request sent from a user who uses the video software, third party video player software may imitate the approach for the user to use the video software to obtain the video content. This may influence the use efficiency of CDNs.

### SUMMARY

The present disclosure provides a method, an electronic device and a system for content pushing to solve the problem of low use efficiency with existing Content Delivery Networks (CDN).

In a first aspect, embodiments of the present disclosure provide a method for content pushing. The method is applied in a client and includes:

obtaining, by the client, a device identity (ID) from an authentication server, wherein the device ID is a unique device identification assigned for the client by the authentication server;

adding the device ID into a request for a content; and

sending the request for the content to a Content Delivery Network (CDN) server, so that the CDN server returns the requested content to the client after authenticating the device ID.

In a second aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for content pushing mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to:

receive a request for a content sent from a client;

determine whether there is a device ID carried in the request for the content, wherein the device ID is a unique device identification assigned for the client by an authentication server; and

if the device ID is carried in the request for the content, send the content corresponding to the request to the client.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for content pushing in accordance with some embodiments.

FIG. 2 is a flow chart of another method for content pushing in accordance with some embodiments.

FIG. 3 is a flow chart of another method for content pushing in accordance with some embodiments.

FIG. 4 is a block diagram of a device for content pushing in accordance with some embodiments.

FIG. 5 is a block diagram of another device for content pushing in accordance with some embodiments.

FIG. 6 is a block diagram of another device for content pushing in accordance with some embodiments.

FIG. 7 is a block diagram of another device for content pushing in accordance with some embodiments.

FIG. 8 is a block diagram of a system for content pushing in accordance with some embodiments.

FIG. 9 is a block diagram showing a structure of a physical CDN server in accordance with some embodiments.

FIG. 10 is a block diagram of an electronic device which is configured to perform the methods for content pushing in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

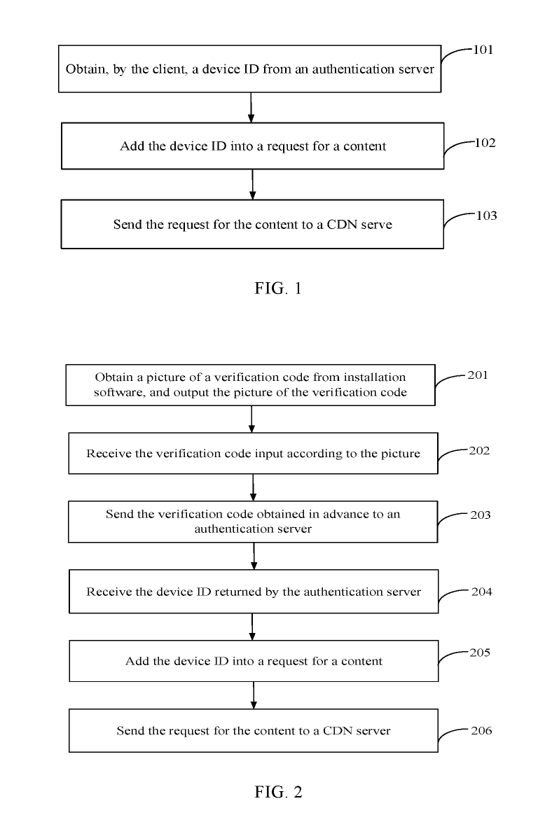

An embodiment of the present disclosure provides a method for content pushing. The method can be applied in a client side. As shown in FIG. 1, the method can include the following steps.

In 101, the client obtains a device ID from an authentication server.

The device ID obtained by the client from the authentication server is a unique device identification assigned for the client by the authentication server. For example, the device ID can be generated based on the following principles: the authentication server obtains a Hash value corresponding to a physical address (for example, a Media Access Control (MAC) address) of the client using a Hash algorithm, and takes the obtained Hash value as the device ID. The device ID assigned for the client can be recorded in the authentication server for subsequent usage.

In 102, the device ID is added into a request for a content.

After obtaining the device ID, the client takes the device ID as the unique device identification of the client. Before sending of each request for a content to a CDN server, the client adds the device ID into the request for the content.

In 103, the request for the content is sent to the CDN server.

After addition of the device ID, the client sends the request for the content containing the device ID to the CDN server, so that the CDN server can return the requested content to the client after authenticating the device ID. In this way, the CDN server can effectively reject unauthorized requests in which no device ID is carried.

In the method for content pushing provided by embodiments of the present disclosure, a client obtains a unique device ID, which is assigned for the client by an authentication server, from the authentication server, and then adds the device ID into a request for a content which is to be sent to a CDN server, so that the CDN server can return the requested content to the client after authenticating the device ID. As compared with prior arts, embodiments of the present disclosure can obtain the assigned device ID, and add the device ID into the request for the content, so that the CDN server can return the requested content to the client after authenticating the device ID in the request for the content sent from the client. Thus, the use efficiency of the CDN can be improved.

Further, embodiments of the present disclosure provide another method for content pushing to give more details about the method described in connection with FIG. 1. As shown in FIG. 2, the method can include the following steps.

In 201, a picture of a verification code is obtained from installation software, and the picture of the verification code is output.

This embodiment relates to installation of a client corresponding to a piece of software. Before using of the software, an installation package of the client corresponding to the software needs to be downloaded firstly, and then the software can be installed. The installation package of the software can have a picture of a verification code added in advance, and thus the picture of the verification code can be obtained from the installation package of the installation software. Then, the picture of the verification code can be output to make users input corresponding verification code according to the picture of the verification code.

In 202, the verification code input according to the picture is received.

The correct verification code input by a user according to the picture of the verification code can be received.

In 203, the verification code obtained in advance is sent to an authentication server.

In this step, the verification code obtained in 202 is sent to an authentication server. It should be noted that verification codes for all installation packages are recorded in the authentication server. Thus, after receiving the verification code sent from the client, the authentication server searches in the recorded verification codes to determine whether there is a verification code which is the same as the received verification code. If there is the same verification code, the authentication server assigns a device ID for the client. For example, the authentication server can assign the device ID in the same way as the generation principles of the device ID in step 101.

In 204, the device ID returned by the authentication server is received.

In 205, the device ID is added into a request for a content.

The addition of the device ID in this step can be implemented the same as the addition of the device ID in step 102, and thus repeated descriptions are omitted.

In 206, the request for the content is sent to a CDN server.

The sending of request in this step can be implemented the same as the sending of request in step 103, and thus repeated descriptions are omitted.

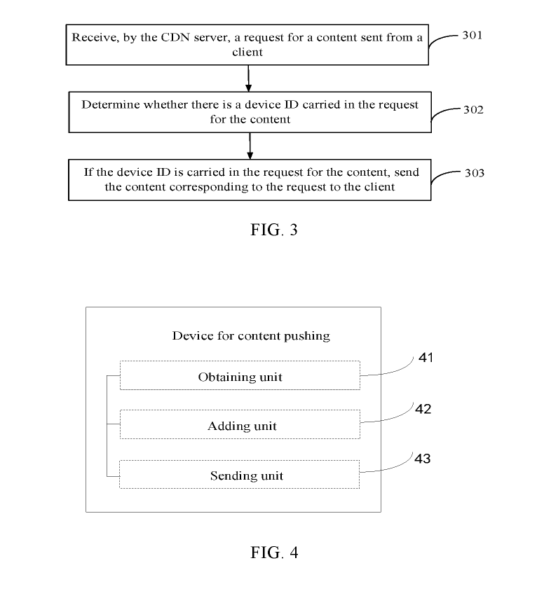

Further, embodiments of the present disclosure provide a method for content pushing. The method can be applied in a CDN server side. As shown in FIG. 3, the method can include the following steps.

In 301, the CDN server receives a request for a content sent from a client.

In 302, whether there is a device ID carried in the request for the content is determined.

When receiving a request for a content sent from a client, the CDN server firstly determines whether there is a device ID carried in the request for the content. The device ID is assigned for the client by an authentication server and serves as a unique device identification of the client.

In 303, if the device ID is carried in the request for the content, the content corresponding to the request is sent to the client.

If the device ID is carried in the request for the content, it can be determined that the request for the content is an authorized request, and then the content corresponding to the request can be sent to the client.

If no device ID is carried in the request for the content, it can be determined that the request for the content is an unauthorized request, and the CDN server can reject the request for the content.

Alternatively, step 303 can be implemented as: if it is determined that the device ID is carried in the request for the content, the device ID carried in the request for the content can be extracted and compared with a backup table of device IDs; if the device ID carried in the request for the content can be found in the backup table of device IDs, the content corresponding to the request is sent to the client; if the device ID carried in the request for the content cannot be found in the backup table of device IDs, the request for the content is rejected. Device IDs of all devices obtained from the authentication server are recorded in the backup table of device IDs.

It should be noted that when installing software, the client sends the verification code to the authentication server which then assigns a unique device identification (i.e., the device ID) for the client, and the device ID is recorded in a table of device IDs in the authentication server. It can be considered that each client which has obtained its device ID can carry the device ID in requests for contents. Thus, by determining whether there is a device ID in requests for contents sent from a client and whether the device ID can be found in the backup table of device IDs, whether the client sending the requests for contents is the client which downloads the software can be determined. By analyzing the device ID in requests for contents, unauthorized requests for free access to requested contents by imitating the requesting action of the client can be effectively recognized.

In the method for content pushing provided by embodiments of the present disclosure, when a CDN server receives a request for a content sent from a client, the CDN server determines whether a unique device ID which is assigned for the client by an authentication server is carried in the request for the content; if the device ID is carried in the request for the content, the CDN server sends the content corresponding to the request to the client. As compared with prior arts, embodiments of the present disclosure can determine whether to send the requested content to the client by determining whether there is the device ID carried in the request for the content. Thus, the use efficiency of the CDN can be improved.

Further, embodiments of the present disclosure provide a device for content pushing to implement the above embodiments. The device can be provided in a client side to implement the above methods described in connection with FIGS. 1 and 2. As shown in FIG. 4, the device can include an obtaining unit 41, an adding unit 42 and a sending unit 43.

The ID obtaining unit 41 is configured to obtain a device ID from an authentication server. The device ID is a unique device identification assigned for the client by the authentication server.

The device ID obtained by the client from the authentication server is a unique device identification assigned for the client by the authentication server. For example, the device ID can be generated based on the following principles: the authentication server obtains a Hash value corresponding to a physical address (for example, a Media Access Control (MAC) address) of the client using a Hash algorithm, and takes the obtained Hash value as the device ID. The device ID assigned for the client can be recorded in the authentication server for subsequent usage.

The adding unit 42 is configured to add the device ID into a request for a content.

After obtaining the device ID, the client takes the device ID as the unique device identification of the client. Before sending of each request for a content to a CDN server, the client adds the device ID into the request for the content.

The sending unit 43 is configured to send the request for the content to a Content Delivery Network (CDN) server, so that the CDN server returns the requested content to the client after authenticating the device ID.

After addition of the device ID, the client sends the request for the content containing the device ID to the CDN server, so that the CDN server can return the requested content to the client after authenticating the device ID. In this way, the CDN server can effectively reject unauthorized requests in which no device ID is carried.

Further, as shown in FIG. 5, the ID obtaining unit 41 includes a sending module 411 and a receiving module 412.

The sending module 411 is configured to send a verification code, which is obtained in advance, to the authentication server.

The receiving module 412 is configured to receive the device ID returned by the authentication server. The device ID is a device ID returned by the authentication server according to the verification code.

Further, as shown in FIG. 5, the device can further include a verification code obtaining unit 44, an outputting unit 45 and a receiving unit 46.

The verification code obtaining unit 44 is configured to obtain a picture of the verification code from installation software before the verification code is sent to the authentication server.

The outputting unit 45 is configured to output the picture of the verification code.

This embodiment relates to installation of a client corresponding to a piece of software. Before using of the software, an installation package of the client corresponding to the software needs to be downloaded firstly, and then the software can be installed. The installation package of the software can have a picture of a verification code added in advance, and thus the picture of the verification code can be obtained from the installation package of the installation software. Then, the picture of the verification code can be output to make users input corresponding verification code according to the picture of the verification code.

The receiving unit 46 is configured to receive the verification code input according to the picture.

The correct verification code input by a user according to the picture of the verification code can be received.

In the device for content pushing provided by embodiments of the present disclosure, a client obtains a unique device ID, which is assigned for the client by an authentication server, from the authentication server, and then adds the device ID into a request for a content which is to be sent to a CDN server, so that the CDN server can return the requested content to the client after authenticating the device ID. As compared with prior arts, embodiments of the present disclosure can obtain the assigned device ID, and add the device ID into the request for the content, so that the CDN server can return the requested content to the client after authenticating the device ID in the request for the content sent from the client. Thus, the use efficiency of the CDN can be improved.

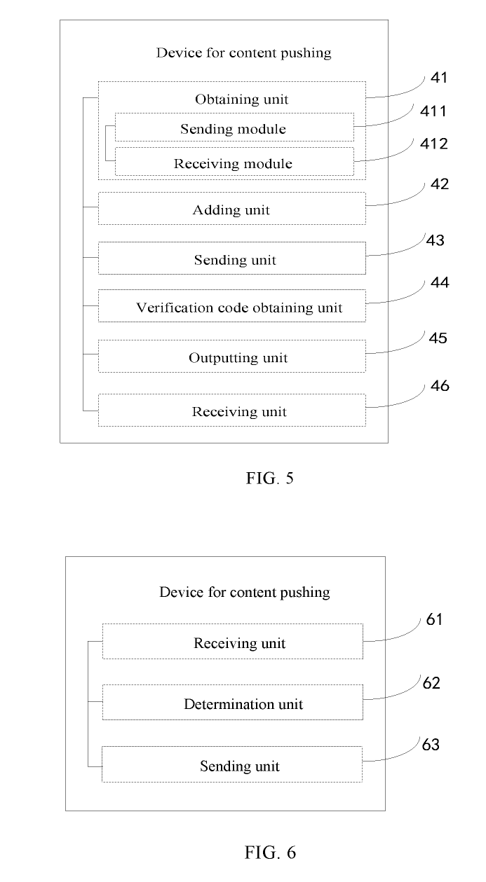

Further, embodiments of the present disclosure provide a device for content pushing. The device can be provided in a CDN server side. The device can be configured to implement the method described in connection with FIG. 3. As shown in FIG. 6, the device can include a receiving unit 61, a determination unit 62 and a sending unit 63.

The receiving unit 61 is configured to receive a request for a content sent from a client.

The determination unit 62 is configured to determine whether there is a device identity (ID) carried in the request for the content. The device ID is a unique device identification assigned for the client by an authentication server.

When receiving a request for a content sent from a client, the CDN server firstly determines whether there is a device ID carried in the request for the content. The device ID is assigned for the client by an authentication server and serves as a unique device identification of the client.

The sending unit 63 is configured to, if the device ID is carried in the request for the content, send the content corresponding to the request to the client.

If the device ID is carried in the request for the content, it can be determined that the request for the content is an authorized request, and then the content corresponding to the request can be sent to the client.

If no device ID is carried in the request for the content, it can be determined that the request for the content is an unauthorized request, and the CDN server can reject the request for the content.

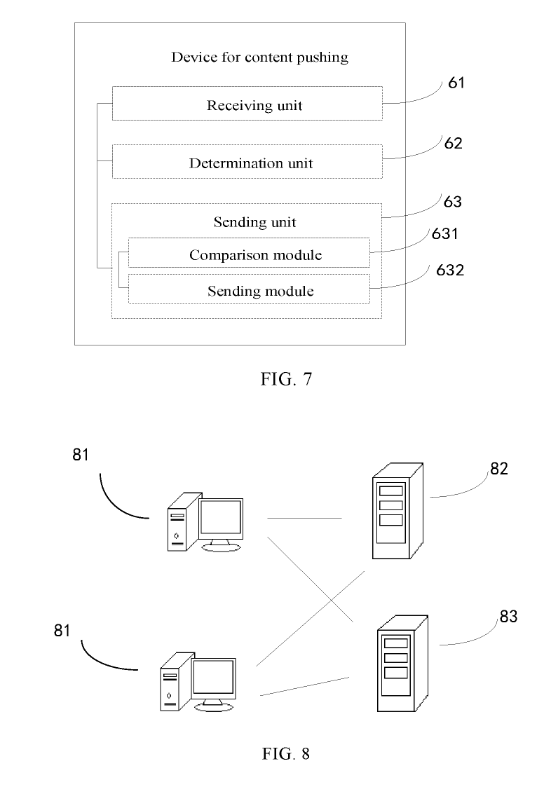

Further, as shown in FIG. 7, the sending unit 63 can include a comparison module 631 and a sending module 632.

The comparison module 631 is configured to compare the device ID with a backup table of device IDs in which device IDs of all devices obtained from the authentication server are recorded.

The sending module 632 is configured to, if there is the device ID in the backup table of device IDs, send the content corresponding to the request to the client.

Specifically, if it is determined that the device ID is carried in the request for the content, the device ID carried in the request for the content can be extracted and compared with a backup table of device IDs; if the device ID carried in the request for the content can be found in the backup table of device IDs, the content corresponding to the request is sent to the client; if the device ID carried in the request for the content cannot be found in the backup table of device IDs, the request for the content is rejected. Device IDs of all devices obtained from the authentication server are recorded in the backup table of device IDs.

In the device for content pushing provided by embodiments of the present disclosure, when a CDN server receives a request for a content sent from a client, the CDN server determines whether a unique device ID which is assigned for the client by an authentication server is carried in the request for the content; if the device ID is carried in the request for the content, the CDN server sends the content corresponding to the request to the client. As compared with prior arts, embodiments of the present disclosure can determine whether to send the requested content to the client by determining whether there is the device ID carried in the request for the content. Thus, the use efficiency of the CDN can be improved.

Further, embodiments of the present disclosure provide a system for content pushing to implement the above methods described in connection with FIGS. 1, 2 and 3. The embodiments of the system correspond to the above embodiments of the methods and can implement all the steps in the embodiments of the methods. For the purpose of easy reading, generic descriptions are provided with respect to the embodiments of the system, and details regarding the system will not be elaborated here. As shown in FIG. 8, the system can include a client 81, an authentication server 82, and a CDN server 83. The client 81 can include the above device as shown in FIG. 4 or 5, and the CDN server can include the above device as shown in FIG. 6 or 7.

The client 81 is configured to: obtain a device identity (ID) from the authentication server, wherein the device ID is a unique device identification assigned for the client by the authentication server; add the device ID into a request for a content; and send the request for the content to the CDN server, so that the CDN server returns the requested content to the client after authenticating the device ID.

The authentication server 82 is configured to assign the device ID for the client.

The CDN server 83 is configured to receive the request for the content sent from the client; determine whether there is the device ID carried in the request for the content; and if the device ID is carried in the request for the content, send the content corresponding to the request to the client.

In the system for content pushing provided by embodiments of the present disclosure, a client obtains a unique device identity (ID), which is assigned for the client by an authentication server, from the authentication server, and then adds the device ID into a request for a content which is to be sent to a CDN server. When the CDN server sends contents to the client, the CDN server firstly determines whether there is the device ID carried in the received request for the content from the client; if the device ID is carried in the request for the content, the CDN server sends the content corresponding to the request to the client. As compared with prior arts, embodiments of the present disclosure can use the authentication server to assign the device ID for the client, and adds the device ID into the request for the content which is to be sent from the client to the CDN server, so that the CDN server can determine whether to send the content to the client according to whether there is the device ID carried in the request. Thus, the use efficiency of the CDN can be improved.

It should be noted that the functions of respective units or modules in the above device for content pushing according to embodiments of the present disclosure can be realized by hardware processors.

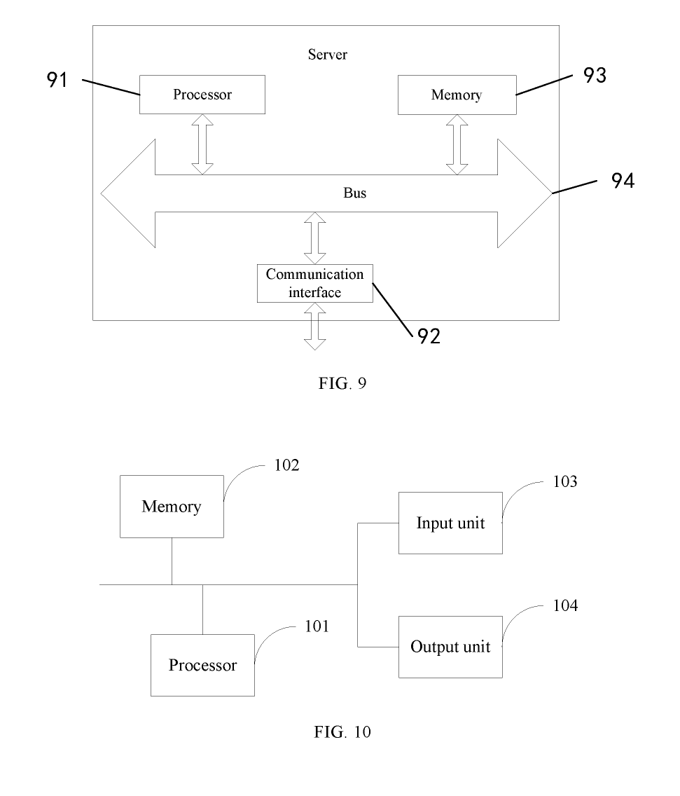

As an example, FIG. 9 is a block diagram showing a structure of a physical CDN server in accordance with an embodiment of the present disclosure. The server can include a processor 91, a communication interface 92, a memory 93 and a bus 94. The processor 91, the communication interface 92 and the memory 93 communicate with each other via the bus 94. The communication interface 92 may be used for information transmission between the server and a client. The processor 91 calls logic instructions in the memory 93 to perform the following method: receiving, by the CDN server, a request for a content sent from a client; determining whether there is a device identity (ID) carried in the request for the content, wherein the device ID is a unique device identification assigned for the client by an authentication server; and if the device ID is carried in the request for the content, sending the content corresponding to the request to the client.

In addition, the logic instructions in the memory 93 may be implemented as software functional units which can be stored in a computer readable storage medium when sold or used as independent products. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for content pushing mentioned by embodiments of the present disclosure.

FIG. 10 is a block diagram of an electronic device which is configured to perform the methods for content pushing according to an embodiment of the present disclosure. As shown in FIG. 10, the device includes:

one or more processors 101 and memory 102. A processor 101 is showed in FIG. 10 for an example.

Device which is configured to perform the methods for content pushing can also include: input unit 103 and output unit 104.

Processor 101, memory 102, input unit 103 and output unit 104 can be connected by BUS or other methods, and BUS connecting is showed in FIG. 10 for an example.

Memory 102 can be used for storing non-transitory software program, non-transitory computer executable program and modules as a non-transitory computer-readable storage medium, such as corresponding program instructions/modules for the methods for content pushing mentioned by embodiments of the present disclosure (such as shown in FIG. 4, obtaining unit 41, adding unit 42 and sending unit 43). Processor 101 performs kinds of functions and content pushing of the electronic device by executing non-transitory software program, instructions and modules which are stored in memory 102, thereby realizes the methods for content pushing mentioned by embodiments of the present disclosure.

Memory 102 can include program storage area and data storage area, thereby the operating system and applications required by at least one function can be stored in program storage area and data created by using the device for content pushing can be stored in data storage area. Furthermore, memory 102 can include high speed Random-access memory (RAM) or non-volatile memory such as magnetic disk storage device, flash memory device or other non-volatile solid state storage devices. In some embodiments, memory 102 can include long-distance setup memories relative to processor 101, which can communicate with the device for content pushing by networks. The examples of said networks are including but not limited to Internet, Intranet, LAN, mobile Internet and their combinations.

Input unit 103 can be used to receive inputted number, character information and key signals causing user configures and function controls of the device for content pushing. Output unit 104 can include a display screen or a display device.

The said module or modules are stored in memory 102 and perform the methods for content pushing when executed by one or more processors 101.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for content pushing, implemented by a client, comprising:
obtaining, by the client, a device identity (ID) from an authentication server, wherein the device ID is a unique device identification assigned for the client by the authentication server;
adding the device ID into a request for a content; and
sending the request for the content to a Content Delivery Network (CDN) server, so that the CDN server returns the requested content to the client after authenticating the device ID.

2. The method according to claim 1, wherein the obtaining of the device ID from the authentication server comprises:
sending a verification code, which is obtained in advance, to the authentication server; and
receiving the device ID returned by the authentication server, wherein the device ID is a device ID returned by the authentication server according to the verification code.

3. The method according to claim 2, wherein before the sending of the verification code to the authentication server, the method further comprises:
obtaining a picture of the verification code from installation software;
outputting the picture of the verification code; and
receiving the verification code input according to the picture.

4. An electronic device, comprising:
at least one processor; and
a memory communicably connected with the at least one processor for storing instructions executable by the at least one processor, wherein execution of the instructions by the at least one processor causes the at least one processor to:
obtain a device ID from an authentication server, wherein the device ID is a unique device identification assigned for the electronic device by the authentication server;
add the device ID into a request for a content; and
send the request for the content to a CDN server, so that the CDN server returns the requested content to the electronic device after authenticating the device ID.

5. The electronic device according to claim 4, wherein the obtaining of the device ID from the authentication server comprises:
sending a verification code, which is obtained in advance, to the authentication server; and
receiving the device ID returned by the authentication server, wherein the device ID is a device ID returned by the authentication server according to the verification code.

6. The electronic device according to claim 5, wherein before the sending of the verification code to the authentication server, the instructions are executed to cause the at least one processor to:
obtain a picture of the verification code from installation software;
output the picture of the verification code; and
receive the verification code input according to the picture.

7. An electronic device, comprising:
at least one processor; and
a memory communicably connected with the at least one processor for storing instructions executable by the at least one processor, wherein execution of the instructions by the at least one processor causes the at least one processor to:
receive a request for a content sent from a client;
determine whether there is a device ID carried in the request for the content, wherein the device ID is a unique device identification assigned for the client by an authentication server; and
if the device ID is carried in the request for the content, send the content corresponding to the request to the client.

8. The electronic device according to claim 7, wherein the sending of the content corresponding to the request to the client comprises:
comparing the device ID with a backup table of device IDs in which device IDs of all devices obtained from the authentication server are recorded; and
if there is the device ID in the backup table of device IDs, sending the content corresponding to the request to the client.
